(19) United States
(12) Patent Application Publication
(10) Pub. No.: US 2004/0246732 A1
(43) Pub. Date: Dec. 9, 2004

(54) SELF-ADJUSTING MOTORCYCLE HEADLIGHT

(76) Inventor: Chad J. Lewis, Beaverton, OR (US)

Correspondence Address: ANTHONY EDW. J CAMPBELL, PO BOX 160370, AUSTIN, TX, 78716, US

(21) Appl. No.: 10/455,904

(22) Filed: Jun. 5, 2003

(51) Int. Cl. B62J 6/00

(52) U.S. Cl. 362/475; 362/473; 362/476; 362/523; 362/512

(57) ABSTRACT

A self-adjusting motorcycle headlight has a housing surrounding a light element and a lean-sensing device. In one embodiment, the lean-sensing is gyroscope, which adjusts a reflector of the light element to maintain a generally planer direction of the light beam emitted by the light element. In an alternative embodiment, an array of lights may be used for the light element, and the lean-sensing element may be used to determine which lights of the array are powered to produce a predetermined beam pattern, which may be generally planer or provide cornering or peripheral lighting. The self-adjusting motorcycle headlight has particular utility in connection with automatically directing light into the direction of travel of a motorcycle.

### BACKGROUND OF THE INVENTION

1. Field of the Invention

The present invention relates to a self-adjusting motorcycle headlight for use in connection with motorcycles. The self-adjusting motorcycle headlight has particular utility in connection with automatically directing light into the direction of travel of a motorcycle.

2. Description of the Prior Art

Self-adjusting motorcycle headlights are desirable for automatically directing light into the direction of travel of a motorcycle.

The use of motorcycle headlights is known in the prior art. For example, U.S. Pat. No. 4,075,469 to Alphen discloses lighting systems for motorcycles. However, the Alphen '469 patent does not provide a self-adjusting motorcycle headlight with multiple light elements each having its own reflector.

U.S. Pat. No. 5,599,085 to Tabata et al. discloses a motorcycle headlight and method for controlling a light distribution thereof. However, the Tabata '085 patent does not provide a self-adjusting motorcycle headlight with multiple light elements each having its own reflector.

U.S. Pat. No. 3,634,677 to Wolffing-Seelig et al. discloses a lighting control for motor vehicle lamps. However, the Wolffing-Seelig '677 patent does not provide a self-adjusting motorcycle headlight with multiple light elements each having its own reflector.

U.S. Pat. No. 4,868,720 to Miyauchi et al. discloses a road surface-sensitive beam pattern leveling system for a vehicle headlamp. However, the Miyauchi '720 patent does not provide a self-adjusting motorcycle headlight with multiple light elements each having its own reflector.

U.S. Pat. No. 4,733,334 to Krey discloses a headlight leveling device for an automobile. However, the Krey '334 patent does not provide a headlight adjustment with respect to a vertical plane, and therefore does not provide a suitable headlight adjustment for a motorcycle which tilts when turning.

U.S. Pat. No. Des. 423,126 to Doss discloses a motorcycle headlight. However, the Doss '126 patent provides only an ornamental design for a motorcycle headlight, and does not provide a self-adjusting motorcycle headlight for automatic direction of light into the direction of travel.

Lastly, U.S. Pat. No. 3,939,339 to Alphen discloses a lighting system for a motorcycle. However, the Alphen '339 patent does not provide a self-adjusting motorcycle headlight with multiple light elements each having its own reflector.

While the above-described devices fulfill their respective, particular objectives and requirements, the aforementioned patents do not describe a self-adjusting motorcycle headlight with multiple light elements each having its own reflector that allows the automatic direction of light into the direction of travel of a motorcycle. The prior art patents make no provision for multiple light elements each having its own reflector.

Therefore, a need exists for a new and improved self-adjusting motorcycle headlight that can be used for automatically directing light into the direction of travel of a motorcycle. In this regard, the present invention substantially fulfills this need. In this respect, the self-adjusting motorcycle headlight according to the present invention substantially departs from the conventional concepts and designs of the prior art, and in doing so provides an apparatus primarily developed for the purpose of automatically directing light into the direction of travel of a motorcycle.

### SUMMARY OF THE INVENTION

In view of the foregoing disadvantages inherent in the known types of motorcycle headlights now present in the prior art, the present invention provides an improved self-adjusting motorcycle headlight, and overcomes the above-mentioned disadvantages and drawbacks of the prior art. As such, the general purpose of the present invention, which will be described subsequently in greater detail, is to provide a new and improved self-adjusting motorcycle headlight and method which has all the advantages of the prior art mentioned heretofore and many novel features that result in a self-adjusting motorcycle headlight which is not anticipated, rendered obvious, suggested, or even implied by the prior art, either alone or in any combination thereof.

To attain this, the present invention essentially comprises a self-adjusting motorcycle headlight, comprising a housing defining a cavity therein, at least one light element within the cavity, at least one reflector connected to at least one light element, and at least one apparatus connected to at least one reflector, wherein the apparatus maintains its position regardless of how the motorcycle is moved.

In one embodiment, the present invention comprises a self-adjusting motorcycle headlight, comprising a housing defining a cavity therein, a first light element within the cavity, a second light element within the cavity, a first reflector connected to the first light element, a second reflector connected to the second light element, and at least one gyroscope element connected to at least one reflector.

In another embodiment, the present invention comprises a self-adjusting motorcycle headlight, comprising a housing defining a cavity therein, a center light element within the cavity, a left side light element within the cavity, a right side light element within the cavity, a center reflector connected to the center light element, a left reflector connected to the left side light element, a right reflector connected to the right side light element, a left gyroscope element connected to the left reflector, and a right gyroscope element connected to the right reflector.

There has thus been outlined, rather broadly, the more important features of the invention in order that the detailed description thereof that follows may be better understood and in order that the present contribution to the art may be better appreciated.

The invention may also include a lean angle-sensing device and additional light elements. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved self-adjusting motorcycle headlight that has all of the advantages of the prior art motorcycle headlights and none of the disadvantages.

It is another object of the present invention to provide a new and improved self-adjusting motorcycle headlight that may be easily and efficiently manufactured and marketed.

An even further object of the present invention is to provide a new and improved self-adjusting motorcycle headlight that has a low cost of manufacture with regard to both materials and labor, and which accordingly is then susceptible of low prices of sale to the consuming public, thereby making such self-adjusting motorcycle headlight economically available to the buying public.

Still another object of the present invention is to provide a new self-adjusting motorcycle headlight that provides in the apparatuses and methods of the prior art some of the advantages thereof, while simultaneously overcoming some of the disadvantages normally associated therewith.

Even still another object of the present invention is to provide a self-adjusting motorcycle headlight for automatically directing light into the direction of travel of a motorcycle. This allows improved driving safety by providing the best possible view of the roadway when making turns.

Still yet another object of the present invention is to provide a self-adjusting motorcycle headlight for automatically directing light into the direction of travel of a motorcycle at night. This makes it possible to see the roadway clearly at night even when accelerating, decelerating, and making turns.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a right elevational view of the preferred embodiment of the self-adjusting motorcycle headlight constructed in accordance with the principles of the present invention and mounted on a motorcycle.

FIG. 2 is a front elevational view of the self-adjusting motorcycle headlight of the present invention.

FIG. 3 is a left elevational cross-sectional view of the self-adjusting motorcycle headlight of the present invention illustrated in FIG. 2 and taken along the line 3-3.

FIG. 4 is a front elevational view of an embodiment of the self-adjusting motorcycle headlight of the present invention comprising three light elements.

FIG. 5 is a cross-sectional plan view of the self-adjusting motorcycle headlight of the present invention illustrated in FIG. 4 and taken along the line 4-4.

The same reference numerals refer to the same parts throughout the various figures.

### DESCRIPTION OF THE PREFERRED EMBODIMENT

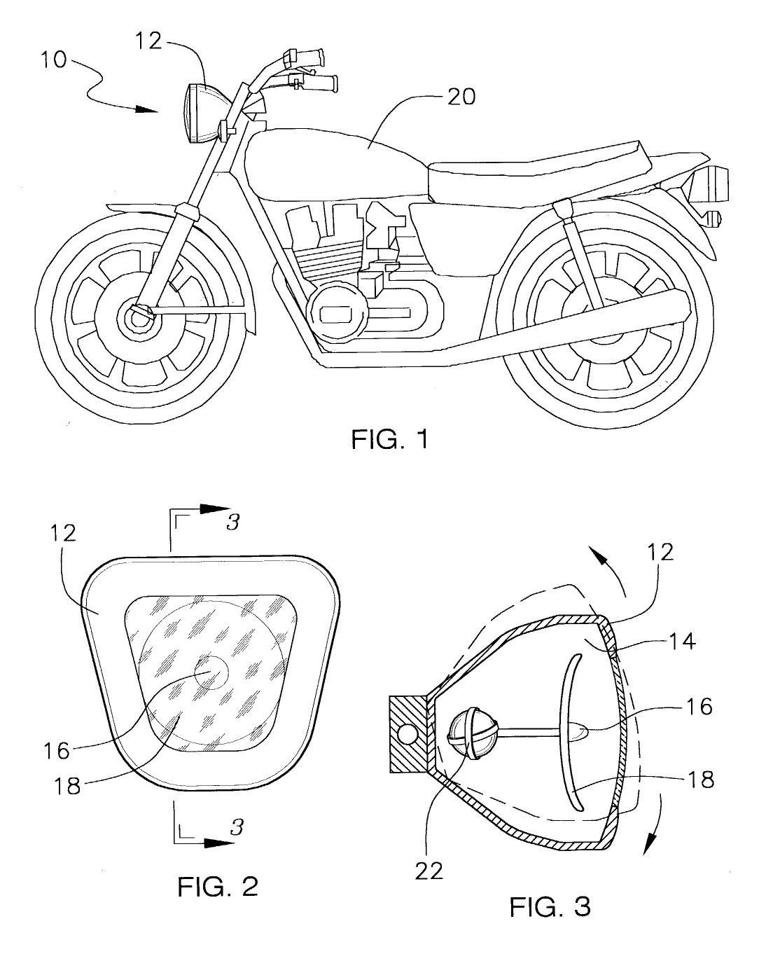

Referring now to the drawings, and particularly to FIGS. 1-5, a preferred embodiment of the self-adjusting motorcycle headlight of the present invention is shown and generally designated by the reference numeral 10.

In FIG. 1, a new and improved self-adjusting motorcycle headlight 10 of the present invention for automatically directing light into the direction of travel of a motorcycle 20 is illustrated and will be described. FIG. 1 is a right elevational view of the preferred embodiment of the self-adjusting motorcycle headlight 10 constructed in accordance with the principles of the present invention, illustrating an outside housing 12 mounted on a motorcycle 20.

FIG. 2 is a front elevational view of the self-adjusting motorcycle headlight of the present invention. More particularly, the self-adjusting motorcycle headlight comprises an outside housing 12 defining a cavity therein, which holds a light element 16, and a reflector 18 connected to the light element 16.

FIG. 3 is a left elevational cross-sectional view of the self-adjusting motorcycle headlight of the present invention, and illustrates a housing 12 defining a cavity 14 therein, a light element 16 within the cavity 14, a reflector 18 connected to the light element 16, and a gyroscope 22 connected to the reflector, wherein the gyroscope 22 maintains its position regardless of how the motorcycle is moved.

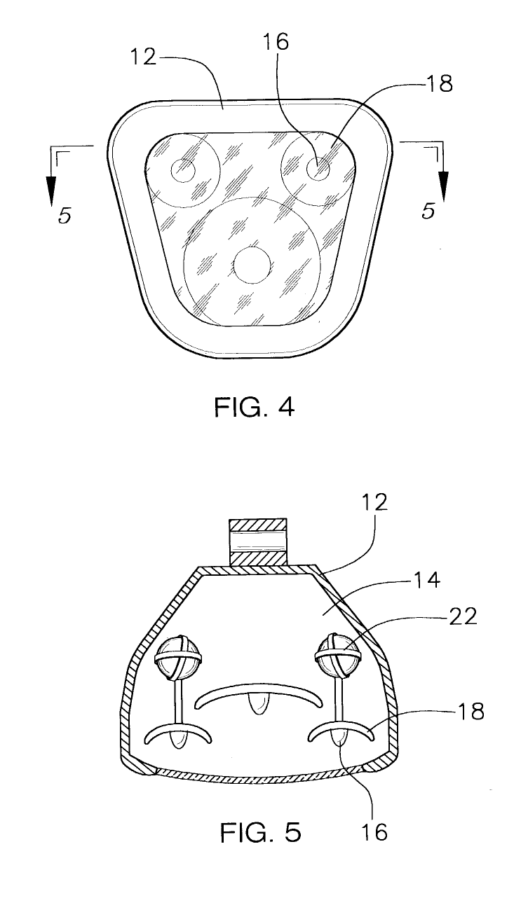

FIG. 4 is a front elevational view of an embodiment of the self-adjusting motorcycle headlight of the present invention comprising three light elements 16, and illustrates a housing 12 defining a cavity therein, a center light element 16 within the cavity, a left side light element 16 within the cavity, a right side light element 16 within the cavity, a center reflector 18 connected to the center light element 16, a left reflector 18 connected to the left side light element 16, and a right reflector 18 connected to the right side light element 16. Hidden in this figure is a left gyroscope element connected to the left reflector 18, and a right gyroscope element connected to the right reflector 18.

FIG. 5 is a cross-sectional plan view of the self-adjusting motorcycle headlight of the present invention, and illustrates a housing 12 defining a cavity 14 therein, a center light element 16 within the cavity 14, a left side light element 16 within the cavity 14, a right side light element 16 within the cavity 14, a center reflector 18 connected to the center light element 16, a left reflector 18 connected to the left side light element 16, a right reflector 18 connected to the right side light element 16, a left gyroscope 22 element connected to the left reflector 18, and a right gyroscope 22 element connected to the right reflector 18. The center reflector 18 is stationary.

The sell-adjusting motorcycle headlight of the present invention is a self-adjusting headlight for new production motorcycles that remains level when leaning into turns at night. Normally, when a rider leans into a turn, a conventional headlight is directed away from the path of the motorcycle. This modified headlight improves driving safety by providing the motorcyclist with the best possible view of the roadway when making turns.

The self-adjusting motorcycle headlight of the present invention operates with the assistance of an apparatus that maintains its position regardless of how the motorcycle is moved. In a preferred embodiment, this apparatus is a gyroscope like those used on aircraft. Any type of gyroscope known in the art can be used, such as gyro gimbals. The gyroscope can be air-powered by ported or bleed engine air or an air pump, or it may be driven by an electric motor. In the present invention, the gyroscope maintains its position, regardless of how the motorcycle is moved. The headlight's reflector dish is linked to the gyroscope so it maintains a level plane, regardless of whether the bike moves up or down, or leans left or right. In this manner, the gyroscope functions as both a lean-angle sensing device and an adjustment mechanism. In an alternative embodiment, an electronic lean-sensing device could be employed. In the alternative embodiment, the lean-sensing device could be coupled to small motors that function to adjust the horizontal and vertical axis positioning of the headlight for optimum forward visibility. In yet another alternative embodiment, an electronic lean-sensing device is used in connection with an array of lights, such as LEDs. The lean-sensing device would then use a switching means, such as a microprocessor and a memory, which would control the array based upon the input from the lean-sensing device. Particular lights of the array would be powered or off to achieve optimal lighting. The light array may be programmed to maintain a generally planer light beam or could also have predetermined lighting patterns, such as lighting specific for cornering or peripheral lighting.

Rotation about the longitudinal axis of the light counteracts the bike's leaning when turning a corner at night. When leaning into a turn, the headlight self-adjusts to the level state so it is directed into the turn. This provides the best possible forward view so the motorcyclist can see the area in the path of the machine. The movement of the assembly can be accomplished by gears, by a direct link to the unit, or by any other method known to those of skill in the art.

During a sudden acceleration of the machine by the rider when the bike tends to lean upward, the gyroscope directs the front headlight downward slightly to keep the roadway ahead properly illuminated. Similarly, a sudden deceleration of the bike in which the machine's front end dips downward causes the headlight to angle upward slightly to provide the desired forward view. The self-adjusting motorcycle headlight is ideally suited for new motorcycle production, and also has utility in kit form for aftermarket motorcycle installations.

The self-adjusting motorcycle headlight of the present invention fulfills the need for a moving motorcycle headlight that is automatically directed into the direction of travel at night. The appealing features of the self-adjusting motorcycle headlight include its automatic operation, safety, and convenience. To keep the headlight level and aimed into the most appropriate direction, the rider simply operates the motorcycle in typical fashion. This eliminates peering into darkness when traveling around curves or when making sharp turns at intersections. With the self-adjusting motorcycle headlight of the present invention, the roadway is always properly illuminated for safe nighttime driving. This relieves some of the stress and anxiety of riding at night, particularly in rural areas where lighting is very limited. It enhances travel safety so serious accidents are avoided. The system is also lightweight, durable, reliable, accurate, and completely automatic. It may comprise plastic, metal, composite material, or combinations thereof.

In a preferred embodiment, the self-adjusting motorcycle headlight of the present invention comprises multiple light elements each having its own reflector. In various embodiments, light bulbs may be stationary with moving reflectors, or both the light bulbs and the reflectors may move together.

In one embodiment, the self-adjusting motorcycle headlight of the present invention comprises a motorcycle headlamp featuring a triangular support housing having three smaller triangular luminescence elements therewithin for forming an unique headlamp capable of following the orientation of a motorcycle, and such that the light beams associated with the present invention maintain a proper orientation with respect to the road level despite the orientation of the motorcycle via a gyroscopic-like sensor and control apparatus. Additional light elements can be designed to turn on when a particular lean angle is sensed. Intensity can also increase for these lights as the lean angle increases.

In use, it can now be understood that the self-adjusting motorcycle headlight of the present invention has particular utility in connection with automatically directing light into the direction of travel of a motorcycle, and is especially useful at night.

While a preferred embodiment of the self-adjusting motorcycle headlight has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, combinations of any suitable material such as metal, plastic, or composite material may be used. Also, the reflector may be made of plastic or metal and the headlight lens may be made of plastic or glass. And although automatically directing light into the direction of travel of a motorcycle has been described, it should be appreciated that the self-adjusting motorcycle headlight herein described is also suitable for flashlights, work lights, and lights for boats and numerous motor vehicles such as off-road vehicles. Furthermore, a wide variety of light and reflector combinations may be used instead of those described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-6. (canceled)

7. A motorcycle headlight, comprising:
a housing defining a cavity therein;
a light element within said cavity;
a lean-sensing device connected to said light element; wherein said lean-sensing device adjusts said light element to maintain a generally level beam of light discharged from said light element regardless of how the motorcycle is moved;
wherein said lean angle-sensing device comprises an electronic sensing element and said electronic sensing element adjusts said light element; and are powered when a particular lean angle is sensed.

8. (canceled).

9. A self-adjusting motorcycle headlight, comprising:
a housing defining a cavity therein;
a first light element within said cavity;
a second light element within said cavity;
a first reflector connected to said first light element;
a second reflector connected to said second light element; and
a lean-angle sensing element connected to at least one said reflector.

10. The self-adjusting motorcycle headlight of claim 9, wherein light beams are automatically directed into the direction of travel despite the orientation of the motorcycle.

11. The self-adjusting motorcycle headlight of claim 9, further comprising at least one additional light element.

12. The self-adjusting motorcycle headlight of claim 9, further comprising at least one additional reflector.

13. The self-adjusting motorcycle headlight of claim 9, wherein said lean angle-sensing device comprises a gyroscope.

14. The self-adjusting motorcycle headlight of claim 13, wherein light intensity increases as lean angle increases.

15. A self-adjusting motorcycle headlight, comprising:
a housing defining a cavity therein;
a center light element within said cavity;
a left side light element within said cavity;
a right side light element within said cavity;
a center reflector connected to said center light element;
a left reflector connected to said left side light element;
a right reflector connected to said right side light element;
a left gyroscope element connected to said left reflector; and
a right gyroscope element connected to said right reflector.

16. The self-adjusting motorcycle headlight of claim 15, wherein light beams are automatically directed into the direction of travel despite the orientation of the motorcycle.

17. The self-adjusting motorcycle headlight of claim 15, further comprising a lean angle-sensing device.

18. The self-adjusting motorcycle headlight of claim 17, wherein light intensity increases as lean angle increases.

19. The self-adjusting motorcycle headlight of claim 17, further comprising at least one additional light element.

20. The self-adjusting motorcycle headlight of claim 19, wherein at least one additional light element turns on when a particular lean angle is sensed.
